(19) United States
(12) Patent Application Publication
(10) Pub. No.: US 2010/0169183 A1
(43) Pub. Date: Jul. 1, 2010

(54) WEB TRANSACTION SYSTEM AND CONTROLLING METHOD THEREOF

(75) Inventors: Shin-Yan Chiou, Hsinchu County (TW); Jun-Bin Shi, Yunlin County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INDUSTRIAL TECHNOLOGY RESEARCH INSTITUTE, Hsinchu (TW)

(21) Appl. No.: 12/429,278

(22) Filed: Apr. 24, 2009

(30) Foreign Application Priority Data
Dec. 25, 2008 (TW) 97150743
Dec. 30, 2008 (CN) 200810190270.8

(51) Int. Cl. G06Q 30/00

(52) U.S. Cl. 705/26

(57) ABSTRACT

A web transaction system and a controlling method thereof are provided. The controlling method of web transaction system includes the following steps. The translating information of a temporary unit is provided to a first service unit by a web transaction system. Whether the temporary unit has received a first transaction element of the first service unit is determined. The translating information of the first service unit is provided to a second service unit. Whether the first service unit has received a second transaction element is determined. If the first service unit has received the second transaction element and the temporary unit has received the first transaction element, then the first transaction element is sent to the second service unit from the temporary unit.

This application claims the benefit of Taiwan application Serial No. 97150743, filed Dec. 25, 2008, the subject matter of which is incorporated herein by reference.

### BACKGROUND OF THE INVENTION

1. Field of the Invention

The invention relates in general to a web transaction system and a controlling method thereof.

2. Description of the Related Art

Online auction is a very popular way of shopping. For the buyers, online auction provides convenient browsing, handy transaction, and transparent pricing, and the venders, online auction saves them inventory problems. Thus, a large amount of time and traffic cost are saved for both the buyers and the vendors. However, along with the popularity of online auction, the instances of fraudulence are also increasing. For example, the vender may scam the buyer by persuading the buyer to go to the ATM to amend the remittance error which may to lead to consecutive deductions of money. Many people have been cheated of money due to the above fraudulence. Also, the vender may intentionally unintentionally leak the buyer's personal data, which may be exploited by a swindler. The swindler may also send a mail to the buyer in the name of the vender to inform the buyer that if the buyer remits the money to a designated account by today, and the buyer will be granted a generous discount. There are numerous instances of fraudulence of this kind.

According to an ordinary transaction method, the buyer and the vender would exchange data first. For example, the vender will provide his name, telephone, email and bank account to the buyer, and the buyer in return will provide his name, telephone, email and postal address to the vender. And this is how would data be leaked.

Another issue is that after a transaction is agreed and the buyer has remitted the money to the vender, the vender disappears deliberately. The buyer will then loose an amount of money. The buyer may lodge a claim to the online auction site. If the buyer is lucky enough, he may receive an indemnity from the online auction site after a complicated and lengthy procedure. However, the indemnity has a ceiling and the buyer needs to cover the loss exceeding the ceiling at his own cost.

### SUMMARY OF THE INVENTION

The invention is directed to a web transaction system and a controlling method thereof. With the design of a temporary unit, the web transaction system and a controlling method thereof assure transaction security and user privacy.

According to a first aspect of the present invention, a controlling method of web transaction system is provided. The controlling method of web transaction system includes the following steps. The translating information of a temporary unit is provided to a first service unit by a web transaction system. Whether the temporary unit has received a first transaction element of the first service unit is determined. The translating information of the first service unit is provided to a second service unit. Whether the first service unit has received a second transaction element is determined. If the first service unit has received the second transaction element and the temporary unit has received the first transaction element, then the first transaction element is sent to the second service unit from the temporary unit.

According to a second aspect of the present invention, a controlling method of web transaction system is provided. The controlling method of web transaction system includes the following steps. Whether a second service unit has received a first transaction element of a first service unit is determined. The translating information of a temporary unit is provided to the second service unit by a web transaction system. Whether the temporary unit has received a second transaction element of the second service unit is determined. If the second service unit has received the first transaction element and the temporary unit has received the second transaction element, then the second transaction element is sent to the first service unit from the temporary unit.

According to a third aspect of the present invention, a controlling method of web transaction system is provided. The controlling method of web transaction system includes the following steps. The translating information of a first temporary unit is provided to a first service unit by a web transaction system. Whether the first temporary unit has received a first transaction element of the first service unit is determined. If the first temporary unit has received the first transaction element, then the translating information of a second temporary unit is provided to a second service unit by the web transaction system. Whether the second temporary unit has received the second transaction element is determined. If the second temporary unit has received the second transaction element, then the second transaction element is sent to the first service unit from the second temporary unit. Whether the first service unit has received the second transaction element is determined. If the first service unit has received the second transaction element, then the first transaction element is sent to the second service unit from the first temporary unit.

According to a fourth aspect of the present invention, a web transaction system is provided. The web transaction system includes a temporary unit, an information providing unit and a determining unit. The information providing unit is for providing the translating information of the temporary unit to a first service unit and providing the translating information of the first service unit to a second service unit. The determining unit is for determining whether the temporary unit has received a first transaction element of the first service unit and determining whether the first service unit has received a second transaction element. If the first service unit has received the second transaction element and the temporary unit has received the first transaction element, then the first transaction element is sent to the second service unit from the temporary unit.

According to a fifth aspect of the present invention, a web transaction system is provided. The web transaction system includes a temporary unit, an information providing unit and a determining unit. The information providing unit is for providing the translating information of the temporary unit to a second service unit. The determining unit is for determining whether the second service unit has received a first transaction element of a first service unit and determining whether the temporary unit has received a second transaction element of the second service unit. If the second service unit has received the first transaction element and the temporary unit has received the second transaction element, then from the temporary unit the second transaction element is sent to the first service unit.

According to a sixth aspect of the present invention, a web transaction system is provided. The web transaction system includes a first temporary unit, a second temporary unit, an information providing unit and a determining unit. The information providing unit is for providing the translating information of the first temporary unit to a first service unit and providing the translating information of the second temporary unit to a second service unit. The determining unit is for determining whether the first whether the temporary unit has received a first transaction element of the first service unit and determining second whether the temporary unit has received the second transaction element. If the first temporary unit has received the first transaction element, then the translating information of a second temporary unit is provided to a second service unit by the web transaction system. If the second temporary unit has received the second transaction element, then the second transaction element is sent to the first service unit from the second temporary unit. If the first service unit has received the second transaction element, then the first transaction element is sent to the second service unit from the first temporary unit.

The invention will become apparent from the following detailed description of the non-limiting embodiments. The following description is made with reference to the accompanying drawings.

### BRIEF DESCRIPTION OF THE DRAWINGS

FIG. 1A shows a web transaction system according to a first embodiment of the invention;

FIG. 1B shows a flowchart of a controlling method of web transaction system according to a first embodiment of the invention;

FIG. 2A shows a web transaction system according to a second embodiment of the invention;

FIG. 2B shows a flowchart of a controlling method of web transaction system according to a second embodiment of the invention;

FIG. 3A shows a web transaction system according to a third embodiment of the invention; and

FIG. 3B shows a flowchart of a controlling method of web transaction system according to a third embodiment of the invention.

### DETAILED DESCRIPTION OF THE INVENTION

### First Embodiment

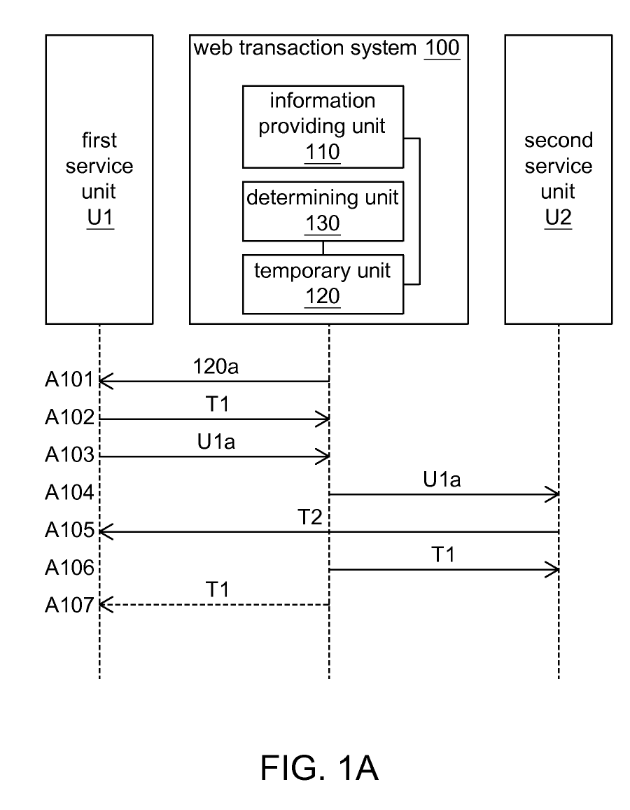

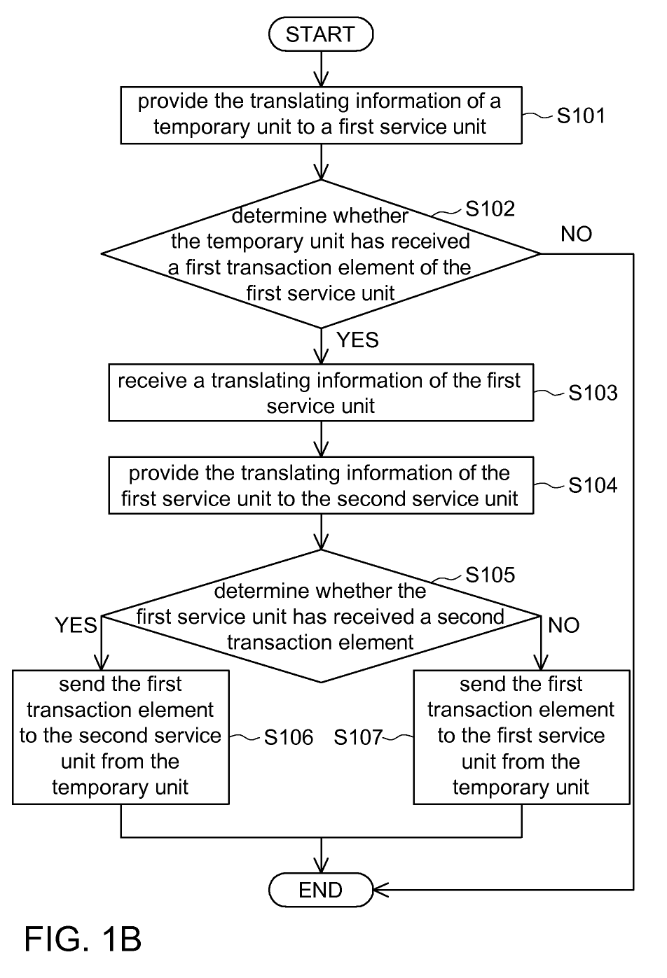

Referring to FIG. 1A, a web transaction system 100 according to a first embodiment of the invention is shown. The web transaction system 100 of the present embodiment of the invention includes a temporary unit 120, an information providing unit 110 and a determining unit 130. The first service unit U1 and the second service unit U2 exchange the first transaction element T1 and the second transaction element T2 through the web transaction system 100 of the present embodiment of the invention. The operation of the web transaction system 100 of the present embodiment of the invention is disclosed below with an accompanying flowchart. The first transaction element T1 and the second transaction element T2 can have three kinds of combination illustrated in Table 1, and are exemplified by the first combination below.

TABLE 1

| | First Transaction | Second Transaction |
|---|---|---|
| | Element T1 | Element T2 |
| First Combination | Money | Object |
| Second | Object | Money |
| Combination | | |
| Third Combination | Object | Object |

Referring to both FIG. 1A and FIG. 1B. FIG. 1B shows a flowchart of a controlling method of web transaction system 100 according to a first embodiment of the invention. Firstly, the method begins at step S101, after a transaction is agreed, a translating information 120a of the temporary unit 120 is provided to a first service unit U1 by the information providing unit 110 (indicated as the information flow A101 of FIG. 1A). The first transaction element T1 and the second transaction element T2 are exemplified by the first combination. The temporary unit 120 of FIG. 1A is a temporary account, and the translating information 120a of the temporary unit 120 includes the information such as remittance notice, corresponding bank, account number and remittance due date. After having received the translating information 120a of the temporary unit 120, the first service unit U1 must send the first transaction element T1 to the temporary unit 120 (indicated as the information flow A102 of FIG. 1A).

Next, the method proceeds to step S102, the determining unit 130 determines whether the temporary unit 120 has received the first transaction element T1. If the temporary unit 120 has received the first transaction element T1, then the method proceeds to step S103. If the temporary unit 120 has not received the first transaction element T1, then the method terminates. The determination in step S102 can be done by the determining unit 130 actively enquiring the temporary unit 120 or by the temporary unit 120 actively sending a receiving notice to the determining unit 130. The first transaction element T1 of FIG. 1A is money, the temporary unit 120 is temporary account, and the action in the information flow A102 is remitting money to the temporary account by the first service unit U1.

Then, the method proceeds to step S103, a translating information U1a of the first service unit U1 is received by the information providing unit 110 (indicated as the information flow A103 of FIG. 1A).

Next, the method proceeds to step S104, the translating information U1a of the first service unit U1 is provided to the second service unit U2 by the information providing unit 110 (indicated as the information flow A104 of FIG. 1A).

Let the first combination of the first transaction element T1 and the second transaction element T2 be taken for example. The translating information U1a of the first service unit U1 of FIG. 1A includes information such as remittance notice, delivery notice, address, consignee and delivery due date. After having received the translating information U1a of the first service unit U1, the second service unit U2 must send the second transaction element T2 to the first service unit U1 (indicated as the information flow A105 of FIG. 1A).

Next, the method proceeds to step S105, the determining unit 130 determines whether the first service unit U1 has received the second transaction element T2. If the first service unit U1 has received the second transaction element T2, then the method proceeds to step S106. If the first service unit U1 has not received the second transaction element T2, then the method proceeds to step S107. The determination in step S105 can be done by the determining unit 130 actively enquiring the first service unit U1 or by the first service unit U1 actively sending a receiving notice to the determining unit 130.

In step S106, meanwhile, the first service unit U1 has received the second transaction element T2. Thus, in step S106, the first transaction element T1 is OK to be sent to the second service unit U2 from the temporary unit 120 (indicated as the information flow A106 of FIG. 1A).

In step S107, meanwhile, the first service unit U1 has not received the second transaction element T2, but the first service unit U1 has sent the first transaction element T1 to the temporary unit 120. Thus, in step S107, the first transaction element T1 must be sent to the first service unit U1 from the temporary unit 120 (indicated as the information flow A107 of FIG. 1A). The information flow A107 denotes that a transaction is not successful and is thus denoted by dotted lines.

Despite the first transaction element T1 and the second transaction element T2 of the first embodiment are exemplified by the first combination, the first transaction element T1 and the second transaction element T2 can also be the second combination or the third combination. As disclosed in Table 1, under the circumstance that the first transaction element T1 and the second transaction element T2 are the second combination or the third combination, the first transaction element T1 is an object. The temporary unit 120 is a temporary warehouse, and the translating information of the temporary unit 120 includes information such as delivery notice, address, consignee and delivery due date.

### Second Embodiment

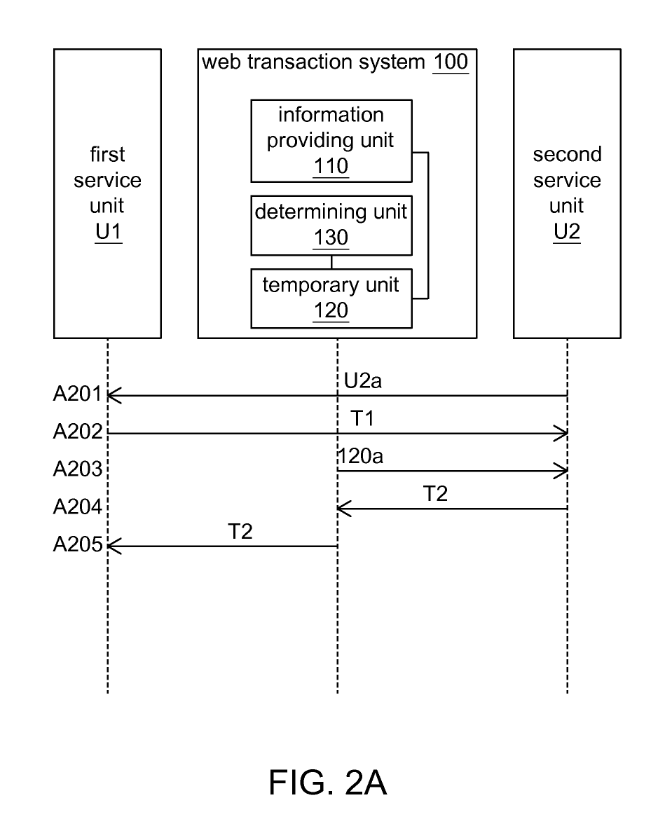

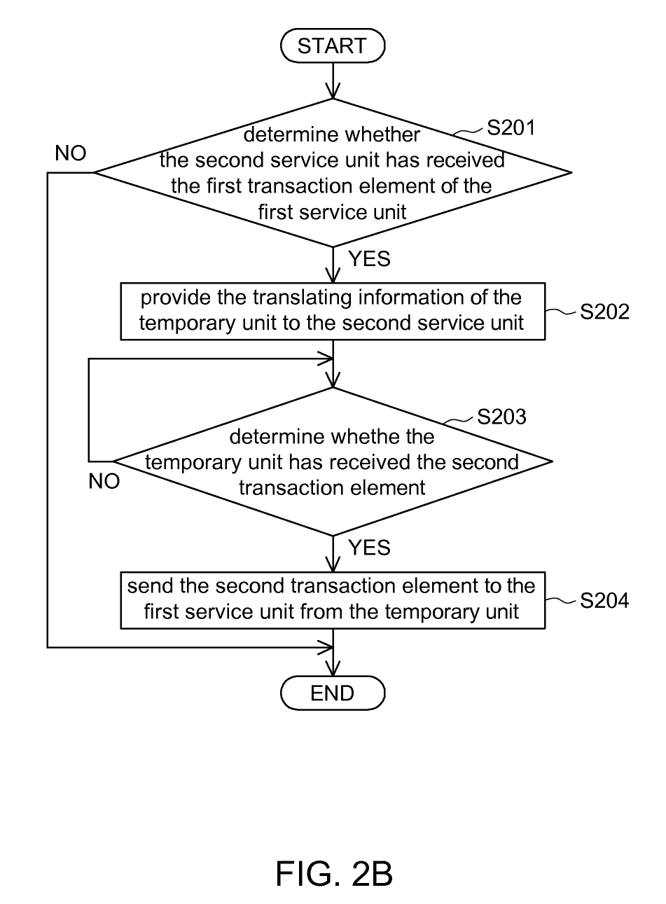

Referring to FIGS. 2A˜2B. FIG. 2A shows a web transaction system 100 according to a second embodiment of the invention. FIG. 2B shows a flowchart of a controlling method of web transaction system 100 according to a second embodiment of the invention. The web transaction system 100 and the controlling method thereof as disclosed in the present embodiment of the invention differ with the web transaction system 100 and the controlling method thereof as disclosed in the first embodiment in that the operation of the temporary unit 120 of the present embodiment of the invention is used in the second transaction element T2. As for other similarities, the same designations are used and are not repeated here. Likewise, the combination of the first transaction element T1 and the second transaction element T2, which can be one of the three kinds of combination illustrated in Table 1, is exemplified by the first combination below.

Firstly, after a transaction is agreed, the second service unit U2 must provides a translating information U2a of the second service unit U2 to the first service unit U1 (indicated as of the information flow A201 of FIG. 2A). Let the first combination of the first transaction element T1 and the second transaction element T2 be taken for example. The translating information U2a of the second service unit U2 of FIG. 2A includes information such as remittance notice, corresponding bank, account number and remittance due date. After having received the translating information U2a of the second service unit U2, the first service unit U1 must send the first transaction element T1 to the second service unit U2 (indicated as the information flow A202 of FIG. 2A).

Next, the method begins at step S201, the determining unit 130 determines whether the second service unit U2 has received the first transaction element T1 of the first service unit U1. If the second service unit U2 has received the first transaction element T1 of the first service unit U1, then the method proceeds to step S202; if the second service unit U2 has not received the first transaction element T1 of the first service unit U1, then the method terminates. The determination in step S201 can be done by the determining unit 130 actively enquiring the second service unit U2 or by the second service unit U2 actively sending a receiving notice to the determining unit 130.

Then, the method proceeds to step S202, a translating information 120a of the temporary unit 120 is provided to the second service unit U2 by the information providing unit 110 (indicated as the information flow A203 of FIG. 2A). After having received the translating information 120a of the temporary unit 120, the second service unit U2 must send the second transaction element T2 to the temporary unit 120. Let the first combination of the first transaction element T1 and the second transaction element T2 be taken for example. The translating information 120a of the temporary unit 120 of FIG. 2A includes information such as remittance notice, delivery notice, address, consignee and delivery due date. After having received the translating information 120a of the temporary unit 120, the second service unit U2 must send the second transaction element T2 to the temporary unit 120 (indicated as the information flow A204 of FIG. 2A).

Next, the method proceeds to step S203, the determining unit 130 determines whether the temporary unit 120 has received the second transaction element T2. If the temporary unit 120 has received the second transaction element T2, then the method proceeds to step S204. If the temporary unit 120 has not received the second transaction element T2, then the method returns to step S203. The determination in step S203 can be done by the determining unit 130 actively enquiring the temporary unit 120 or by the temporary unit 120 actively sending a receiving notice to the determining unit 130.

After that, the method proceeds to step S204, meanwhile, the temporary unit 120 has received the second transaction element T2. Thus, in step S204, the second transaction element T2 is sent to the first service unit U1 from the temporary unit 120 (indicated as the information flow A205 of FIG. 2A).

Despite the first transaction element T1 and the second transaction element T2 of the second embodiment are exemplified by the first combination, the first transaction element T1 and the second transaction element T2 can also be the second combination or the third combination. As disclosed in Table 1, under the circumstance that the first transaction element T1 and the second transaction element T2 are the second combination, the second transaction element T2 is money. The temporary unit 120 is a temporary account, and the translating information of the temporary unit 120 includes information such as remittance notice, corresponding bank, account number and remittance due date.

Moreover, under the circumstance that the first transaction element T1 and the second transaction element T2 are the third combination, the second transaction element T2 is an object. The temporary unit 120 is a temporary warehouse, and the translating information of the temporary unit 120 includes information such as delivery notice, address, consignee and delivery due date.

### Third Embodiment

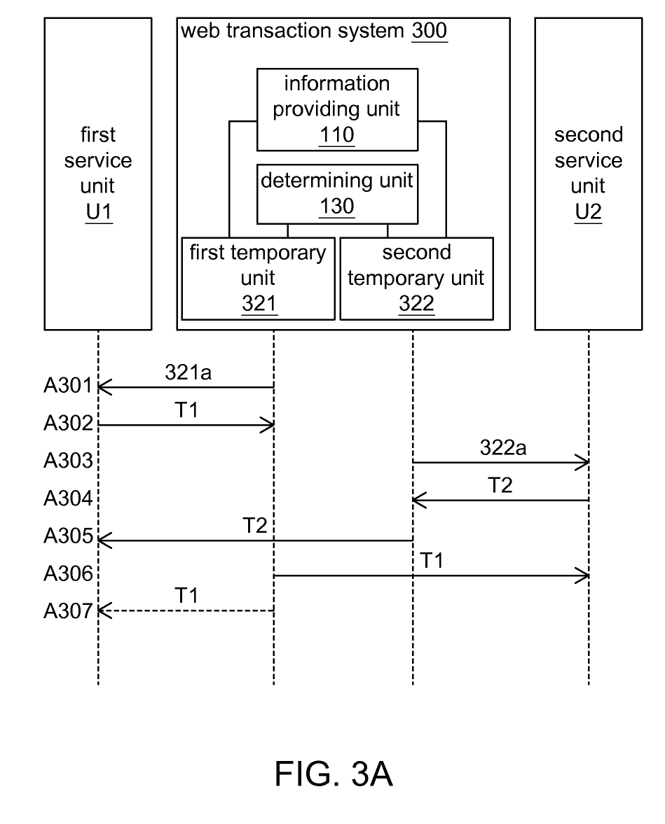

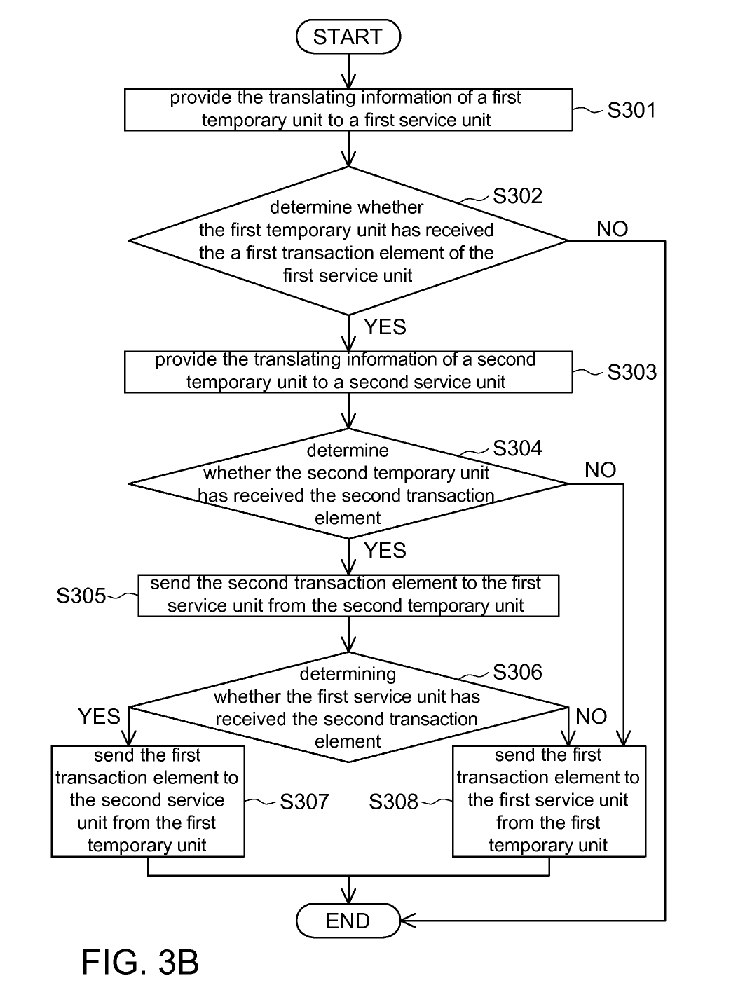

Referring to FIGS. 3A˜3B. FIG. 3A shows a web transaction system 300 according to a third embodiment of the invention. FIG. 3B shows a flowchart of a controlling method of web transaction system 300 according to a third embodiment of the invention. The web transaction system 300 and the controlling method thereof as disclosed in the present embodiment of the invention differ with the web transaction system 100 and the controlling method thereof as disclosed in the first embodiment in that the web transaction system 300 of the present embodiment of the invention includes two temporary units (the first temporary unit 321 and the second temporary unit 322). As for other similarities, the same designations are used and are not repeated here. Likewise, the combination of the first transaction element T1 and the second transaction element T2, which can be one of the three kinds of combination illustrated in Table 1, is exemplified by the first combination below.

Firstly, the method begins at step S301, after a transaction is agreed, a translating information 321a of the first temporary unit 321 is provided to the first service unit U1 by the information providing unit 110 (indicated as the information flow A301 of FIG. 3A). Let the first combination of the first transaction element T1 and the second transaction element T2 be taken for example. The first temporary unit 321 of FIG. 3A is a temporary account, and the translating information 321 a of the first temporary unit 321 includes information such as remittance notice, corresponding bank, account number and remittance due date. After having received the translating information 321a of the first temporary unit 321, the first service unit U1 must send the first transaction element T1 to the first temporary unit 321 (indicated as the information flow A302 of FIG. 3A).

Next, the method proceeds to step S302, the determining unit 130 determines whether the first temporary unit 321 has received the first transaction element T1 of the first service unit U1. If the first temporary unit 321 has received the first transaction element T1 of the first service unit U1, then the method proceeds to step S303. If the first temporary unit 321 has not received the first transaction element T1 of the first service unit U1, then the method terminates. The determination in step S302 can be done by the determining unit 130 actively enquiring the first temporary unit 321 or by the first temporary unit 321 actively sending a receiving notice to the determining unit 130.

Then, the method proceeds to step S303, a translating information 322a of the second temporary unit 322 is provided to the second service unit U2 by the information providing unit 110 (indicated as the information flow A303 of FIG. 3A). After having received the translating information 322a of the second temporary unit 322, the second service unit U2 must send the second transaction element T2 to the second temporary unit 322 (indicated as the information flow A304 of FIG. 3A)

Next, the method proceeds to step S304, the determining unit 130 determines whether the second temporary unit 322 has received the second transaction element T2. If the second temporary unit 322 has received the second transaction element T2, then the method proceeds to step S305. If the second temporary unit 322 has not received the second transaction element T2, then the method proceeds to step S308. The determination in step S304 can be done by the determining unit 130 actively enquiring the second temporary unit 322 or by the second temporary unit 322 actively sending a receiving notice to the determining unit 130.

In step S305, the second transaction element T2 is sent to the first service unit U1 from the second temporary unit 322 (indicated as the information flow A305 of FIG. 3A). Let the first combination of the first transaction element T1 and the second transaction element T2 be taken for example. The translating information 322a of the second temporary unit 322 FIG. 3A includes remittance information such as notice, delivery notice, address, consignee and delivery due date.

In step S306, the determining unit 130 determines whether the first service unit U1 has received the second transaction element T2. If the first service unit U1 has received the second transaction element T2, then the method proceeds to step S307. If the first service unit U1 has received the second transaction element T2, then the method proceeds to step S308. The determination in step S306 can be done by the determining unit 130 actively enquiring the first service unit U1 or by the first service unit U1 actively sending a receiving notice to the determining unit 130.

Following that, the method proceeds to step S307, meanwhile, the first temporary unit 321 has received the first transaction element T1, and the first service unit U1 also has received the second transaction element T2. Thus in step S307, then the first transaction element T1 is OK to be to the second service unit U2 from the first temporary unit 321 (indicated as the information flow A306 of FIG. 3A).

Then, the method proceeds to step S308, meanwhile, the second temporary unit 322 or the first service unit U1 has not received the second transaction element T1, but the first service unit U1 has sent the first transaction element T1 to the first temporary unit 321. Thus, in step S308, the first transaction element T1 is sent back to the first service unit U1 from the first temporary unit 321 (indicated as the information flow A307 of FIG. 3A). The information flow A307 denotes that a transaction is not successful and is denoted by dotted line here.

Despite the first transaction element T1 and the second transaction element T2 of the third embodiment are exemplified by the first combination, the first transaction element T1 and the second transaction element T2 can also be the second combination or the third combination. As disclosed in Table 1, under the circumstance that the first transaction element T1 and the second transaction element T2 are the second combination, the first transaction element T1 is an object and the second transaction element T2 is money. Meanwhile, the first temporary unit 321 is a temporary warehouse, the second temporary unit 322 is a temporary account, the translating information of the temporary unit 321 includes information such as delivery notice, address, consignee and delivery due date, and the translating information of the second temporary unit 322 includes information such as remittance notice, corresponding bank, account number and remittance due date.

Moreover, under the circumstance that the first transaction element T1 and the second transaction element T2 are the third combination, each of the first transaction element T1 and the second transaction element T2 is an object. Meanwhile, each of the first temporary unit 321 and the second temporary unit 322 is a temporary warehouse, and the translating information of the first temporary unit 321 and the second temporary unit 322 each includes information such as delivery notice, address, consignee and delivery due date.

According to the web transaction system and the controlling method thereof disclosed in the above embodiments of the invention, with the design of the temporary unit, the first service unit still could get the first transaction element back to avoid being scammed by the second service unit, under the circumstance that the second transaction element could not be received, The second service unit could send the first transaction element only when the first transaction element is received to avoid being scammed by the first service unit. The first service unit could perform transaction as long as the translating information of the temporary unit is obtained, so the second service unit does not need to disclose his personal information to the first service unit, hence assuring the security of the personal information of the second service unit. The second service unit could perform transaction as long as the translating information of the temporary unit is obtained, so the first service unit does not need to disclose his personal information to the second service unit, hence assuring the security of the personal information of the first service unit.

While the invention has been described by way of example and in terms of an embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A controlling method of web transaction system, comprising:
providing the translating information of a temporary unit to a first service unit by a web transaction system;
determining whether the temporary unit has received a first transaction element of the first service unit;
providing the translating information of the first service unit to a second service unit;
determining whether the first service unit has received a second transaction element of the second service unit; and
sending the first transaction element to the second service unit from the temporary unit if the first service unit has received the second transaction element and the temporary unit has received the first transaction element.

2. The controlling method of web transaction system according to claim 1, wherein the first transaction element is money, the second transaction element is an object, the temporary unit is a temporary account, the translating information of the temporary unit comprises an account number, and the translating information of the first service unit comprises an address.

3. The controlling method of web transaction system according to claim 1, wherein the first transaction element is an object, the second transaction element is money, the temporary unit is a temporary warehouse, the translating information of the temporary unit comprises an address, and the translating information of the first service unit comprises an account number.

4. The controlling method of web transaction system according to claim 1, wherein each of the first transaction element and the second transaction element is an object, the temporary unit is a temporary warehouse, the translating information of the temporary unit comprises an address, and the translating information of the first service unit comprises an address.

5. The controlling method of web transaction system according to claim 1, further comprising:
sending the first transaction element to the first service unit from the temporary unit if the first service unit has not received the second transaction element and the temporary unit has received the first transaction element.

6. A controlling method of web transaction system, comprising:
determining whether a second service unit has received a first transaction element of a first service unit;
providing the translating information of a temporary unit to the second service unit by the web transaction system;
determining whether the temporary unit has received a second transaction element of the second service unit; and
sending the second transaction element to the first service unit from the temporary unit if the second service unit has received the first transaction element and the temporary unit has received the second transaction element.

7. The controlling method of web transaction system according to claim 6, wherein the first transaction element is money, the second transaction element is an object, the temporary unit is a temporary warehouse, the translating information of the temporary unit comprises an address, and the translating information of the first service unit comprises an address.

8. The controlling method of web transaction system according to claim 6, wherein the first transaction element is an object, the second transaction element is money, the temporary unit is a temporary account, the translating information of the temporary unit comprises an account number, and the translating information of the first service unit comprises an account number.

9. The controlling method of web transaction system according to claim 6, wherein each of the first transaction element and the second transaction element is an object, the temporary unit is a temporary warehouse, the translating information of the temporary unit comprises an address, and the translating information of the first service unit comprises an address.

10. A controlling method of web transaction system, comprising:
providing the translating information of a first temporary unit to a first service unit by the web transaction system;
determining whether the first temporary unit has received a first transaction element of the first service unit;
providing the translating information of a second temporary unit to a second service unit by the web transaction system if the first temporary unit has received the first transaction element;
determining whether the second temporary unit has received the second transaction element;
sending the second transaction element to the first service unit from the second temporary unit if the second temporary unit has received the second transaction element;
determining whether the first service unit has received the second transaction element; and
sending the first transaction element to the second service unit by the first temporary unit if the first service unit has received the second transaction element.

11. The controlling method of web transaction system according to claim 10, wherein the first transaction element is money, the second transaction element is an object, the first temporary unit is a temporary account, the translating information of the first temporary unit comprises an account number, the second temporary unit is a temporary warehouse, and the translating information of the second temporary unit comprises an address.

12. The controlling method of web transaction system according to claim 10, wherein the first transaction element is an object, the second transaction element is money, the first temporary unit is a temporary warehouse, the translating information of the first temporary unit comprises an address, the second temporary unit is a temporary account, and the translating information of the second temporary unit comprises an account number.

13. The controlling method of web transaction system according to claim 10, wherein each of the first transaction element and the second transaction element is an object, each of the first temporary unit and the second temporary unit is a temporary warehouse, and each of the first temporary unit and the translating information of the second temporary unit comprises an address.

14. The controlling method of web transaction system according to claim 10, further comprising:
sending the first transaction element to the first service unit from the first temporary unit if the second temporary unit or the first service unit has not received the second transaction element and the first temporary unit has received the first transaction element.

15. A web transaction system, comprising:
a temporary unit;
an information providing unit for providing the translating information of the temporary unit to a first service unit and providing the translating information of the first service unit to a second service unit; and
a determining unit for determining whether the temporary unit has received the a first transaction element of the first service unit and determining whether the first service unit has received a second transaction element;
wherein if the first service unit has received the second transaction element and the temporary unit has received the first transaction element, then the first transaction element is sent to the second service unit from the temporary unit.

16. The web transaction system according to claim 15, wherein the first transaction element is money, the second transaction element is an object, the temporary unit is a temporary account, the translating information of the temporary unit comprises an account number, and the translating information of the first service unit is an address.

17. The web transaction system according to claim 15, wherein the first transaction element is an object, the second transaction element is money, the temporary unit is a temporary warehouse, the translating information of the temporary unit comprises an address, and the translating information of the first service unit comprises an account number.

18. The web transaction system according to claim 15, wherein each of the first transaction element and the second transaction element is an object, the temporary unit is a temporary warehouse, the translating information of the temporary unit comprises an address, and the translating information of the first service unit is an address.

19. The web transaction system according to claim 15, wherein if the first service unit has not received the second transaction element and the temporary unit has received the first transaction element, then the first transaction element is sent to the first service unit from the temporary unit.

20. A web transaction system, comprising:
a temporary unit;
an information providing unit for providing the translating information of the temporary unit to a second service unit; and
a determining unit for determining whether the second service unit has received a first transaction element of a first service unit and determining whether the temporary unit has received a second transaction element of the second service unit;
wherein if the second service unit has received the first transaction element and the temporary unit has received the second transaction element, then the second transaction element is sent to the first service unit from the temporary unit.

21. The web transaction system according to claim 20, wherein the first transaction element is money, the second transaction element is an object, the temporary unit is a temporary warehouse, the translating information of the temporary unit comprises an address, and the translating information of the first service unit comprises an address.

22. The web transaction system according to claim 20, wherein the first transaction element is an object, the second transaction element is money, the temporary unit is a temporary account, the translating information of the temporary unit comprises an account number, and the translating information of the first service unit comprises an account number.

23. The web transaction system according to claim 20, wherein each of the first transaction element and the second transaction element is an object, the temporary unit is a temporary warehouse, the translating information of the temporary unit comprises an address, and the translating information of the first service unit comprises an address.

24. A web transaction system, comprising:
a first temporary unit;
a second temporary unit;
an information providing unit for providing the translating information of the first temporary unit to a first service unit and providing the translating information of the second temporary unit to a second service unit; and
a determining unit for determining whether the temporary unit has received the a first transaction element of the first service unit, determining whether the second temporary unit has received the second transaction element and determining whether the first service unit has received the second transaction element;
wherein if the first temporary unit has received the first transaction element, then the translating information of a second temporary unit is provided to a second service unit by the web transaction system; if the second temporary unit has received the second transaction element, then the second transaction element is sent to the first service unit from the second temporary unit; if the first service unit has received the second transaction element, then the first transaction element is sent to the second service unit from the first temporary unit.

25. The web transaction system according to claim 24, wherein the first transaction element is money, the second transaction element is an object, the first temporary unit is a temporary account, the translating information of the first temporary unit comprises an account number, the second temporary unit is a temporary warehouse, and the translating information of the second temporary unit comprises an address.

26. The web transaction system according to claim 24, wherein the first transaction element is an object, the second transaction element is money, the first temporary unit is a temporary warehouse, the translating information of the first temporary unit comprises an address, and the second temporary unit is a temporary account, and the translating information of the second temporary unit comprises an account number.

27. The web transaction system according to claim 24, wherein each of the first transaction element and the second transaction element is an object, each of the first temporary unit and the second temporary unit is a temporary warehouse, and each of the first temporary unit and the translating information of the second temporary unit comprises an address.

28. The web transaction system according to claim 24, wherein if the second temporary unit or the first service unit has not received the second transaction element and the first temporary unit has received the first transaction element, then the first transaction element is sent to the first service unit from the first temporary unit.
